(19) United States
(12) Patent Application Publication
(10) Pub. No.: US 2004/0156958 A1
(43) Pub. Date: Aug. 12, 2004

(54) Package of food product

(76) Inventors: Liliya Nissim, Brooklyn, NY (US); Yelena Shifman, Cherry Hill, NJ (US); Sergey Sushchenko, Brooklyn, NY (US)

Correspondence Address: Liliya Nissim, 2nd Floor, 4650 Bedford Ave., Brooklyn, NY, 11235, US

(21) Appl. No.: 10/752,867

(22) Filed: Jan. 5, 2004

Related U.S. Application Data
(60) Provisional application No. 60/438,076, filed on Jan. 6, 2003.
(60) Provisional application No. 60/441,271, filed on Jan. 21, 2003.

(51) Int. Cl. A23L 3/00

(52) U.S. Cl. 426/241

(57) ABSTRACT

The present invention provides manufacture and assembly of food package which possess all of the advantages of packages, and keep product in good condition or remain product safe quality during transport process, keep this product in good condition at keeping process as well, and also keep this product in good condition during sale and in non-bacteria atmosphere always. This method used decreased vacuum while the safest time is increased for all food products drastically. The characteristic feature of filter package is that filter can consist of microchip for increasing filter efficiency and filter capability, and substance treating of small and big particles removing of contamination and poisoning of substance.

Package of manufactured food product can be folded most time when package is not used. Package is made mostly from hard plastic material or another nonmetal always material board as needed this food product, or appropriate material for this country and for this situation, visible for customer needs always as well. This package minimizes electrical devices, production equipment and laboratory stuff expenses as well.

System mostly automatical, allow to implement this system step-by-step, and which can be and really partly applied to solve a problem climate or medicine control for any person.

### CROSS-REFERENCE TO RELATED APPLICATIONS

With reference to the improvement by this invention, and in the discussion with the follows, attention is directed to the prior art. It is well known that certain products are preserved best in the ordinary package, but certain, for instance, foods, such as wine and ground coffee, are preserved best under a vacuum, while others, such as sparkling water, some wines and carbonated soda, do best under pressure. Also certain foods, such as cakes, some candies like chocolate candies, some biscuits, meet, chicken and like the same, are need to be preserved during transport process and, for safety best, at the refrigerator and/or under vacuum. Other liquid and/or not liquid substances, such as drug or medicine, are current used without vacuum or prepressurized. We used a few articles from sourse titled as, “The Best of NASA's Spinoffs” at the subtitle “Food Processing Control” and “Microbe Detector” (http://neurolab.nasa.gov/er/seh/spinoff.html). First article describes that Pillsbury developed the Hazard Analysis and Critical Control Point concept, designed to prevent food safety. The second article describes that device incorporates space technology significantly reduce analysis time. Also we used article from the same sourse subtitled as “Gas Analyzer” which is the way to separate gases into components, identify them, and measure their concentrations. U.S. Coast Guard workers employ the portable chromatography system to identify unknown substances in public areas that might be hazardous. Next article describes that not a floral displey, but a practical wastewater treatment facility—a field of floating water hyacinths that absorb and digest pollutants in wasterwater. The technology stems from NASA studies of water reclamation system for long-duration spacecraft. Next article subtitled, “Water Filter/Conditioner,” describes technology developed to purify space shuttle water . . . . Ionics used the NASA technology as a springboard for development of a silver carbon so dense that it would remain on top of the water-softening resin bed where, company research indicated, the greatest bacterial growth occurs. After extensive testing, the Environmental Protection Agency, EPA, evaluated the IQ's silver carbon process and confimmed its ability to effectively inhibit bacterial growth. “Pool Purification” about space-based system yields pool and spa water that exceeds EPA standards for drinking water . . . . The system is available in the U.S. and 42 other countries. The Carribien Clear Automatic Pool Purifier company makes model for purifying everything from residential hot tubs to six-million-galon commercial pool. In addition to private pool owners, Carribien Clear numbers among its customers the U.S. Navy; Holiday Inn, Marriott, and Sheraton hotels; YMCA facilities; and many health clubs. The system also can be employed to kill algae and bacteria in fish ponds, fountains, and cooling towers. A low-coast, high-efficiency alternative to complex dehumidification systems used in supermarkets.

“Document Monitor” imaging technology is helping to preserve same of America's most treated documents . . . . The Charters of Freedom Monitoring System is designed for early detection of damage to documents in the National Archives.

Wrapper material has exhaust valve as air-jacket to make, for example, a certain vacuum inside housing of package, and package manufacture as well as above mentioned. The food industry product of the present invention is therefore to provide product package, and this product can be easily taken out of this kind of package. The need for any kind of package for the any kind of products, for instance foods, is well-known. Typically, intelligently designed products and its package is utilized to maximize sale product, trade of products and minimize the mainly microwave-heated expenses.

From sources which we can reach (books, US and WIPO patents, marketing invention, all of possible manufacturers, product development and prototyping, license this kind of patent, companies seeking new food package products) it is obvious that for any purpose this kind of product, foods mainly microwave-heated, trade of foods and its package which we are proposed in this improvement invention is not used like it was before. It is mean that previous to the present invention, the use of this kind packages have not been before. For instance, we used US Government following patens and results in 1790-2002 db for: “The packaging” and “Triangle form”; “Package of food product ” and “Triangular form of package”; “Package of product” and “Triangular form”; “Package of product” and “Square form”; “Package material” and “Rectangular, Square form”; “The form of package material” and “Rectangular, Square”; “Controlled package” and “Food”; “Manufacture chamber” and “Substances from liquids”, “Coca Cola sparkling”; “Sparkling purified water”: 0 patents, no patents have matched all of this kind of query. For “Package material” and “Liquid Substance” we found only two (2) US patents; for “Package material” and “Solid Substance” we found only two (2) US patents, for “Disposable package” and “Food material” we found also only two (2) US patents, for “Package assembly” and Cake we found only three (3) US patents, for “Package assembly” and Food we found only seventy one (71) US patents, and for “Package material” and Food we found two hundred and sixty three (263) US patents; for “Soda sparkling” we found only two (2) US patents, and for “Water sparkling” we found nineteen (19) US patents, “Chamber, bottle” and “Liquid” we found one hundred and three (103) US patents which some of them we have used. For example, we used also Search for sponsored site as food containers at KaTom.com, Hubert—Servicing Food Industry Needs, Tupperware—Free Gift With Every Order and Search for Web Site as Plastic and Bulk Food Storage Containers—The Container Store, Restaurant Kitchen Supplies—Ace Mart, Picnic House as well. For instance, researchers from the University of Tokyo and Toyota Central Research and Development Laboratories in Japan have found a group of metal alloys that are unusually strong and flexible. We found a few results and used same of them as well. But the above mentioned and following additional patents also have some relationship to the subject of product, mainly food and its container: U.S. Pat. Nos. 6,490,792; 6,454,088; 6,439,508; 6,432,750; 6,392,313; 6,209,718; 6,105,760; 6,076,676; 6,060,095; 6,046,506; 5,996,845; 5,996,550; 5,927,294; 5,821,424; 5,766,830; 5,743,071; 5,234.105 5,102,627; 5,101,999; 5,048,260; 4,987,280; 4,786,773; 4,629,056; 4,622,693; 4,283,427. In addition we used also Search for sponsored site as Vegetarians in Paradise/Food Irradiation/Food Safety; www.Aaoobfoods.com/oneyearfood supplies.htm; Food Product Design: Form and Function—Restructured Meats; Food Preservation Products; Crevice Food Packing; Food Dehydrator American Harvest—Servicing Food Industry Needs. But the above mentioned and following additional patents also have some relationship to the subject of chambers or package of food product: U.S. Pat. Nos. 6,202,871, 5,031,785, 6,372,472, 6,309,757, 6,197,192, 5,902,643, 5,840,825, 5,728,430, 5,549,037, 5,460,846, 5,260,081, 5,188,755, 4,795,557, 4,526,541, 4,508,235, 4,301,009, 4,219,423, 4,153,181. We found a few resultsas mentioned above and used same of them as well. These patents are not as pertinent to the subject matter of this invention, however most of them dealing with another substance and package, not so close as present invention.

### FEDERALLY SPONSORED RESEARCH OR DEVELOPMENT

The present application is a Continuation of:

(1) application #60/438,076, filing date Jan. 6, 2003, confirmation #9830, date mailed Mar. 3, 2003, entitled “Food Product Package And Its' Manufacture”, license for foreign filing under title 35, United States Code, Section 184 Title 37, Code of Federal Regulations, 5.11 & 5.15,

(2) disclosure document No. 538908, filing date Sep. 18, 2003, date mailed to author Oct. 22, 2003, entitled: “A CHAMBER,” Organization OIPE DD, Bldg/Room CP2, United States Patent and Trademark Office—1652 (August 1999).

The present application is a Continuation in Part of:

(1) application #60/441.271, filing date Jan. 21, 2003, confirmation #6052, date mailed Apr. 9, 2003, entitled “Materials for dust product, method for wrapping and device for manufacture bags those products”, license for foreign filing under title 35, United States Code, Section 184 Title 37, Code of Federal Regulations, 5.11 & 5.15,

(2) disclosure document No. 537832, filing date Sep. 2, 2003, date mailed to author Oct. 2, 2003, entitled: “MECHANICAL SYSTEM AND IT'S MICROINTEGRATED CIRCUITS,” Organization OIPE DD, Bldg/Room CP2, United States Patent and Trademark Office—1652 (August 1999).

(3) disclosure document No. 539315, filing date Sep. 12, 2003, date mailed to author Oct. 23, 2003, entitled: “Device for Produce Microintegrated Circuits of Medicine Dose Intake,” authors Liliya Nissim, Sergey Sushchenko, Organization OIPE DD, Bldg/Room CP2, United States Patent and Trademark Office—1652 (August 1999).

(4) disclosure document No. 539375, filing date Sep. 29, 2003, date mailed to author Oct. 23, 2003, entitled: “System of Diagnosis, Medication Dose Intake, and Treatment”, authors Shifman M., Shifman Y., Nissim L., Sushchenko S., Organization OIPE DD, Bldg/Room CP2, United States Patent and Trademark Office—1652 (August 1999).

### BACKGROUND OF THE INVENTION

1. Field of the Invention

The present invention relates to package of product, mainly food and/or medicine. More particularly, to improvements in hollow body of mainly foods and/or medicine and package assembly any kind of, as example, microwave-heated, as well as to a method for manufacture package and/or a few example product packages consists of microintegrated circuits.

2. Summary of the Invention

### BRIEF DESCRIPTION OF THE VIEW OF THE DRAWING

Reference being made to the accompanying drawings of the present invention in which: on the every pictures the number before dot (point) is mentioned the number of certain figure, number after dot (point) is mentioned the position of this certain figure, and two doted lines mentioned a cut of this certain figure, where:

On FIG. 1 is a perspective view of baked large cake.

On FIG. 2 is a perspective view of baked also large cake, but at this case there are constant, nonmovable entered sensors.

On FIG. 3 is a perspective view of baked few different products.

There on FIG. 4 is a perspective view of microwave oven which consist of two sections.

On FIG. 5 is a perspective view of elevated provision of covers.

FIG. 6 there have shown another approach of this invention—perspective view two handles of food package.

On FIG. 7 is a perspective geometry according to the one embodiment of the present invention of baked food product.

On FIG. 8 shown a perspective view also of housing as above mentioned, but at this case there are a few windows.

On FIG. 9 is a perspective view according to another embodiment of the present invention of baked food product, but there are a few different products.

There on FIG. 10 is a perspective view of rectangular, for instance, housing which consist of a few exhaust valves.

On FIG. 11 is the detailed schematic cross sectional view of the present invention illustrating chamber assembly all of mainly parts for liquids.

On FIG. 12A÷12C are the schematic cross sectional view body, for instance, of chamber.

On FIGS. 13A÷13B are the schematic cross sectional view closure, for instance, of body chamber.

### BRIEF DESCRIPTION OF THE PRESENT INVENTION

The goal of this present invention is mainly to increase manufacture of these materials and parts, which are made from different materials in common case, and to increase assembly of these parts. The goal of this present invention is also to increase manufacture of products, for example, which are microwave-heated, and finally food and/or medicine package manufacture as well. Also goal of this present invention is mainly to increase housing with wrapping assembly to make certain vacuum. Sometimes food and/or medicine package are include microintegrated circuit(s) and particle analysis, and bacteria grouth analysis in fluid as well.

The present invention provides system and method which possess all of the advantages of the advanced food or medicine package which have increased or remain safe quality food even when substance is backed, and/or hold substance in non-bacteria atmosphere.

There briefly described what is shown on each FIGS. 1 to 16, and we have shown all of main parts on each figures embodiment the backed and package food product of the present invention. It will be apparent that any previous backed process of food can be employed in conjunction with either of the other a few expedients used to increased or remain safe quality of substance in this proposed package. There also described what can package after backing with example at particular figure. Thereby, this invention works very easy, and also there is not needed to describe work of this one in detail. The package of manufactured product can be maked with hard plastic or another material board as needed this product.

While the particular package and it manufacture as herein shown and briefly described is fully capable of attaining described objects of the invention, it is to be understood that it is the presently preferred embodiment of the present invention and thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims.

### DETAILED DESCRIPTION OF THE PRESENT INVENTION

On FIG. 1 is a perspective view of baked large cake 1.1 which have three layers as brown layer 1.2, white layer 1.3, and yellow layer 1.4, which longitudinal is L (shown on FIG. 1 by this letter and pointer with both ends) and width W (shown on FIG. 1 by this letter and pointer with both ends as well), sensors from 1.5 to 1.7 next to baked food (in this case is large cake 1.1), but these sensors from 1.5 to 1.7 are not touch the baked food (they evaluate and operate temperature outside or inside of baked food product at the distance), where 1.5 is an evaluating temperature inside food, 1.6 is an evaluating temperature outside food, 1.7 is a sensor of color of food surface; these sensors from 1.5 to 1.7 are movable at this case and are connected to movable also board 1.13 which through contact connected to nonmovable (constant) contact 1.16 of constant board 1.14. Where from 1.8 to 1.12 are connectors of constant board 1.14. These contacts, as contacts from sensors 1.5 to 1.7, are bonded by audio patch cords 1.17. There 1.8 is contact for color; 1.9 is contact for evaluating temperature of surface baked product; 1.10 is contact for evaluating temperature given depth inside of baked product; 1.11 is constant contact for combination of time and heat (depends on evaluating temperature surface and/or inside of baked product); 1.12 is constant contact for number of baked product where are all of accumulating for today data about each baked product according to given number. Bake separately layers from 1.2 to 1.4 or not it is depends many factors, the main of them is determination of laboratory stuff. 1.18 is constant contact for the direction movable of this baked product as shown on FIG. 1 by errow (pointer) with one end.

Can we use the letter L and W for some dimensions, first of all for laboratory stuff? Yes, ended. For example, the longitudinal L of baked product depends on combination of time and heat as V/L=t where V is the speed of baked product, nonconstant value, depends on complex factors. Therefore the t as time of heat is also nonconstant value which depends on mainly evaluating temperature and longitudinal L of baked product. Width W of baked product is operate of number consequently sensors needed for consequent baked product. It is every thing theoretically. But it is very useful and very aim for laboratory stuff first of all. The L and W of baked product minimize consequently the laboratory personnel.

On FIG. 2 is a perspective view of baked also large cake 2.1 but at this case there are constant, nonmovable entered sensors 2.2 and constant, nonmovable exit sensors 2.3 of baked product 2.1. The direction of move baked product is shown by pointer 2.4.

On FIG. 3 is a perspective view of baked few different products from 3.1 to 3.3 simultaneously at the same oven in the same industrial microwave. The sensors from 3.4 to 3.6 are occupied, but they are different sensors, they are busy, only sensor 3.7 is free. The baked product 3.1 has two layers 3.8 and 3.9 where half of top layer is covered by 3.10 straight like chocolate. Baked product 3.2 has only one layer, but half top of it is covered the same as previous, but cover goes two different connected sides and curls diagonal. The baked product 3.3 has three layers from 3.11 to 3.13 where top layer 3.13 is like wafer. It is minimize the heated equipment and electrical expenses. It is more close to practice. How to combine previous theoretical results with practical results? Now it is time for practical experience of laboratory personnel which is now equipped with theoretical results.

Each sensor from 3.4 to 3.7 have own electrical element heater. And each sensor made from nonmetal material like ceramic, plastic, or another material suitable for this country and for this problem, but, once again, non-metal material. Each sensor heated together with baked product. Each sensor give a signal not only automatically, but also sound signal to heat it. This signal means mainly temperature, and means to change this particular sensor, or change particular heated element. This sound signal is different in these different cases.

There on FIG. 4 is a perspective view of microwave oven which consist of two sections 4.1 and interval (break) of them 4.2. Sections 4.1 are used for consequence heating, but interval 4.2 is used for consequence cover if needed these particular food.

On FIG. 5 is a perspective view of elevated provision of covers 5.1 by consequence mechanical brush 5.2.

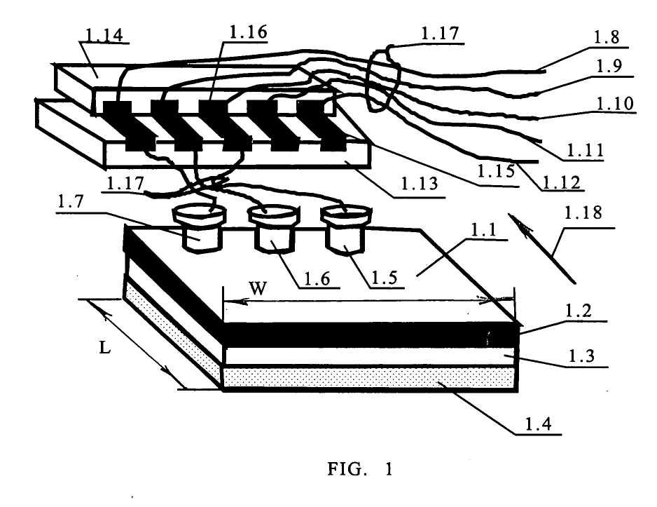

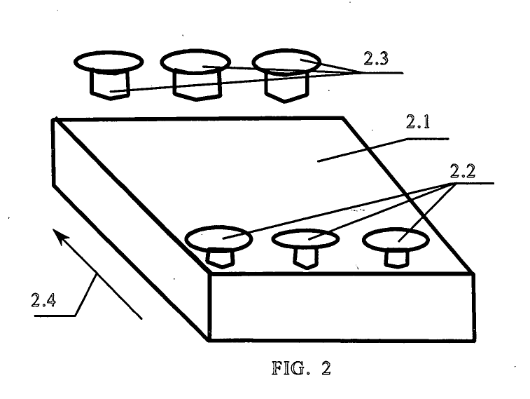

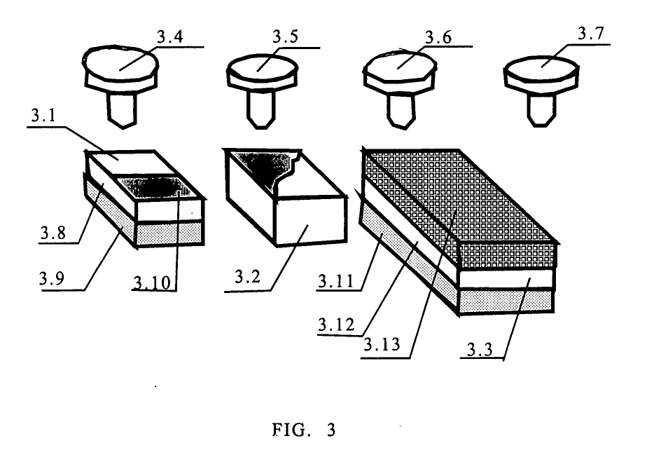

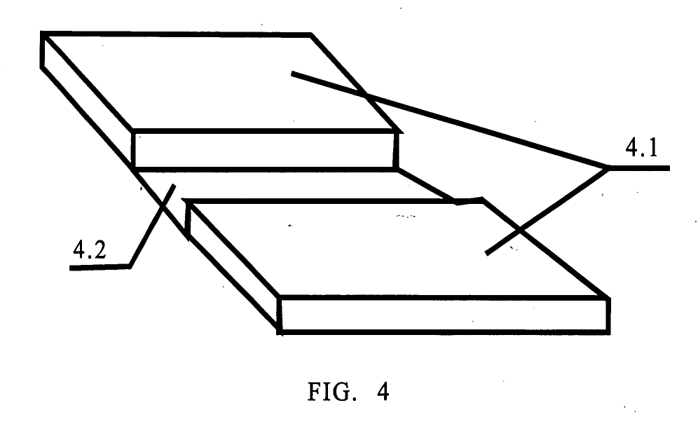

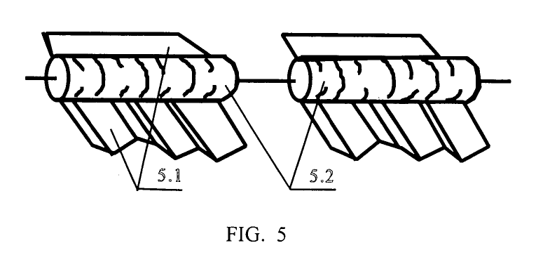

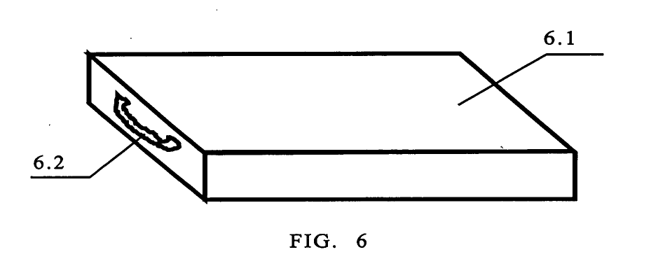

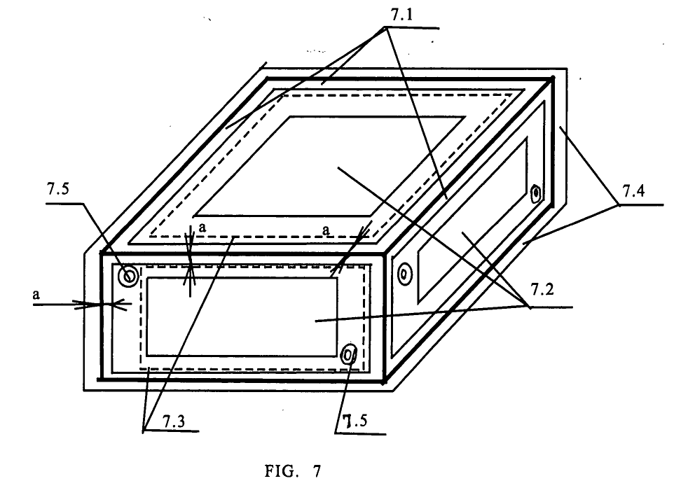

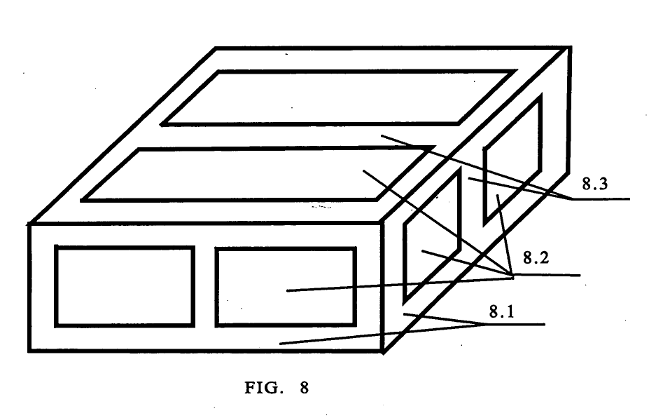

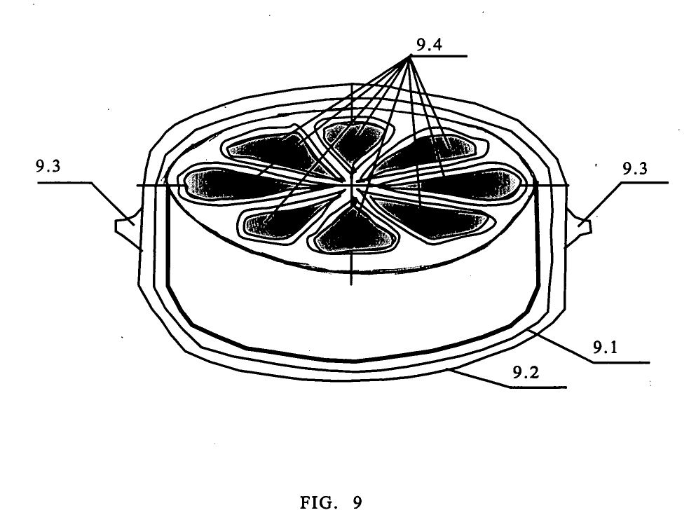

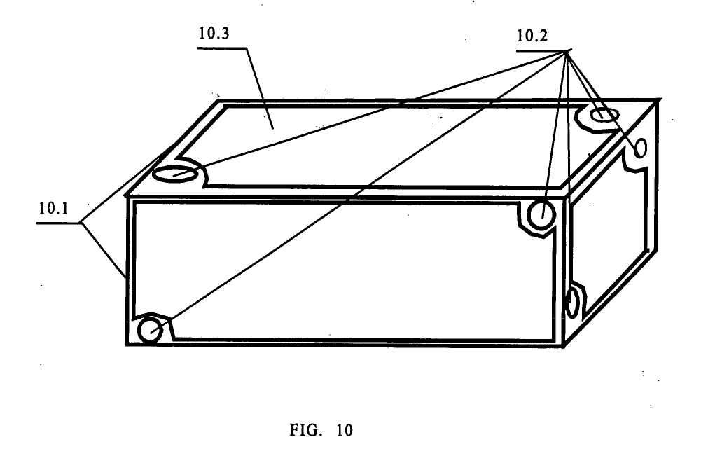

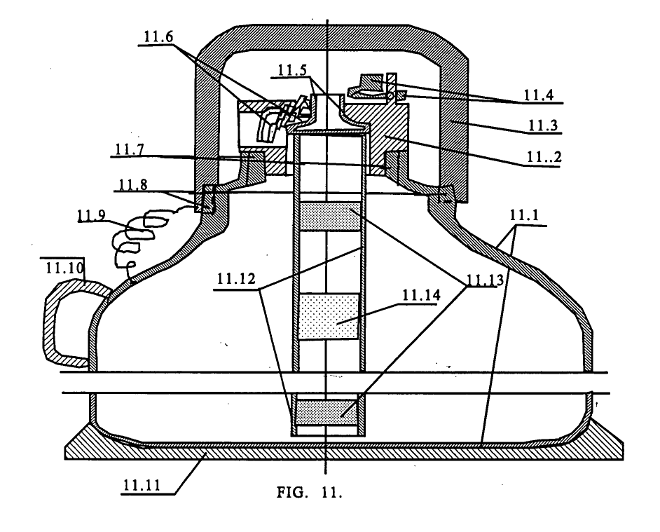

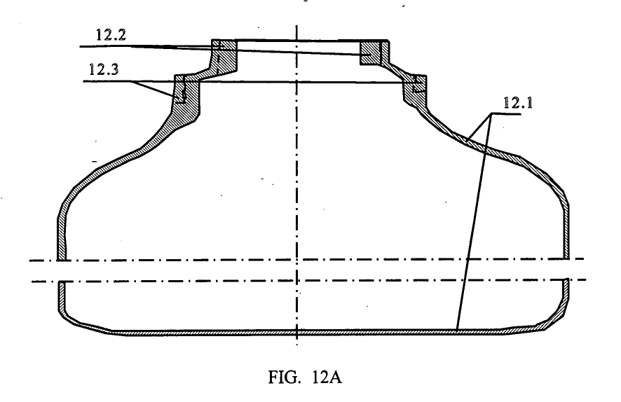

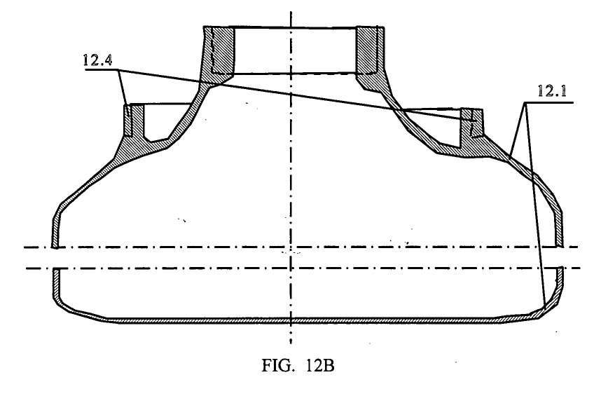

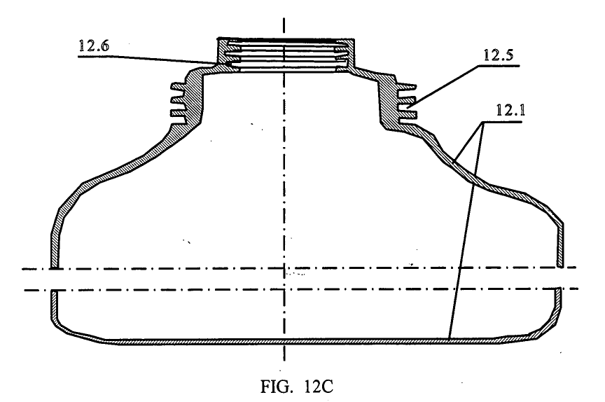

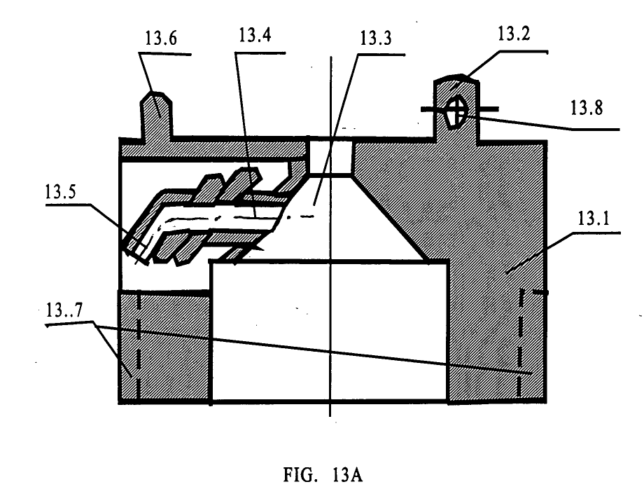

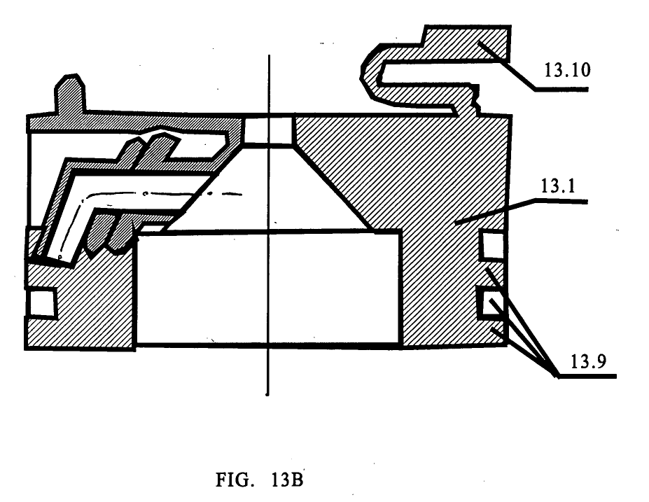

FIG. 6 have shown another approach of this invention to perspective view of backed food package 6.1 have two handles 6.2. These handles 6.2 can be made at the back of package if this substance is so huge as large cake or this baked food have to be open for the transport process.

On FIG. 7 is a perspective geometry according to the one embodiment of the present invention of baked food product, for instance, large cake, which is exploded housing 7.1 of essential package each rectangular part which is glued along of full corner (is not shown at this and another figures) and flexible film interposed between the food product and the package if needed; 7.2 are windows at the housing use only for lighten weight, and it is the optional; 7.3 is the food product, for instance, large cake; 7.4 is the wrapper material which covers the housing; and 7.5 is exhaust valves each of them are located at the different high for the convenience (comfort) of vacuum inside housing, and “a” with an errow is the measure of, for instance, thickness of the housing.

On FIG. 8 shown a perspective view also of housing 8.1 but at this case there are a few windows 8.2 at each rectangular part of package with partition 8.3 of baked food product for its safety and also for sale. This also keep this product in good condition during sale in non-bacteria atmosphere always.

On FIG. 9 is a perspective view according to another embodiment of the present invention of baked food product but few different products from 7 to 8 figures at the same invention of the same industrial package. There 9.1 is housing essential package each circle form of cross-sectional view from up to down, and are rectangular form each part of any side view. 9.2 is the wrapper material which covers the housing; 9.3 is exhaust valve each of them are located at the different high for the convenience (comfort) of vacuum inside housing; 9.4 are plurality of concave recesses for food products as chocolate candies as well. There on FIG. 10 is a perspective view of rectangular, for instance, housing 10.1 which consist of a few exhaust valve 10.2 each of them are located at the different high for the convenience (comfort) of vacuum inside housing 10.1, but 10.3 are only the place for windows like, not a real windows of housing 10.1, and also the valve 10.2, as you can see, made directly at the housing 10.1 out of wrapper material which covers the housing 10.1. The last is minimize wrapper material as well.

The present invention provides assembly of package which possess all of the advantages of food product and manufacture various kind of food product in good condition of package as well, or remain safe quality during transport process, keep this product in good condition at keeping process also as well.

It is above briefly described what is shown on each FIGS. 7 to 10, and we have shown all of main parts on each above figures embodiment the backed and package of food of the present invention. It will be apparent that any previous transport process of food can be employed in conjunction with either of the other a few expedients used to increased or remain safe quality of this kind substance. Thereby, this invention works very easy, and also there is not needed to describe work of invention at this time. The package of manufactured food product can be made with hard plastic or another material as needed this food product. There is a possibility to make housing and wrapper through is visible of sale product. It is very important for customer to know which kind of food person is buying. And also there is a possibility to save the vacuum as it used at food saver (sold used vacuum device for $43.33) and patented (see above). For instance, for baked and covered products it is needed only quarter of usual used vacuum, and for meat it is needed only half of usual used vacuum. And also the sale increased for baked and/or covered products from (0.8÷0.9) to (0.95÷0.97), and from (0.83÷0.87) to (0.91÷0.96) for meet products. Analogous, the vegetables and fruits out of refrigerator is needed only quarter of usual used vacuum. The safest time is increased for baked and/or covered products from approximately one month with refrigerator to 2÷2.5 month out of refrigerator, and from approximately one month with refrigerator to 1.5÷1.8 month out of refrigerator for meet products, and for the vegetables and fruits with refrigerator from 1÷1.5 month to 2÷2.2 month out refrigerator usual used vacuum. There we were used the method whicn was developed by Dan Miller from National Center of Toxicology, Arcansas State (Russian Newpaper published in America “Russian Reclama”(“Russian Commercial), Dec. 27, 2002, Jan. 02, 2003. Tel. 718-769-3000, FAX 718-769-4700).

Why the usual used vacuum is decreased while the safest time is increased for all food products drastically? We described this by “briefing” all food product when the valve give a possibility to out of air inside of housing when the temperature is increased, but do not a possibility of air with bacteria let in (admit) inside of housing and/or wrapper when the temperature is decreased. We think there is needed more investigation. The package and/or wrapper can be folded while they are not used.

On FIG. 11 is the detailed schematic cross sectional view of the present invention illustrating package as a chamber: assembly all of mainly parts for liquids, for instance, which illustrating principles of body chamber or bottle 11.1 where 11.1 can be made from any material for food and/or liquids appropriate, for example, from plastic, or made to use a drug or medicine material, for example, made from ceramics either from metallic, or from non-metallic ceramic. There are now hundreds of different types of plastic, and other are being developed. New materials and processes may provide solutions, but in the meantime, scientists are developing more environmentally friendly materials for the current millennium. A closure 11.2 is for chamber 11.1. A cover 11.3 also is for chamber 11.1. This cover 11.3 can be used as a cup or stemware with, for instance, inner thread as shown on FIG. 11. Sometimes folding cover 11.4 is exactly for output valve 11.5. Valve 11.5 can have a few protrudes (hill), and this protrudes are welded to the body of closure 11.2, when needed, and also when protrudes inner diameter is more bigger than outer diameter of output pipe 11.12. Folding output 11.6 exactly for closure 11.2. An output tube 11.6 is stright the begining and the end of substance, also folding one is on the middle and also is made as one with output hole of closure 11.2, for instance, made from plastic material. There 11.7 is inner thread of head chamber 11.1, enter to outer thread of closure 11.2, and 11.8 is outer thread of chamber 11.1 as well which is entered to inner thread of cover 11.3. The tread 11.9 is for chamber 11.1 and for cover 11.3. The handle 11.10 made, when the handle is needed, but also the handle 11.10 can be as fill in, or as fill out of body chamber 11.1. The stand 11.11 is for chamber 11.1. Output pipe 11.12 going from inside end of valve 11.5 to lower end of substance.

Filters 11.13 are usually two which are located usually near the ends of pipe 11.12, and used for cleaning of small particles substance. Filter 11.14 are usually located at the middle of pipe 11.12, and used for cleaning of big particles substance. All of three filters can be made as microintegrated circuits for small particles—11.12, and for the big particles substance—11.14 to make more efficient filter. One doted line all of drawings is axis line, and two doted line all of drawings as well as are cut out of this part if this part is so long, for instance, on the FIG. 11 these doted lines cut out a body of chamber 11.1.

On FIG. 12A÷12C are the schematic cross sectional view body chamber 12.1. There on FIG. 12A is shown a body of chamber 12.1. The inner thread 12.2 for closure, and outer thread 12.3 for cover of chamber 12.1. There outer thread 12.4 on FIG. 12B is made at the protrude of chamber 12.1 which is more easy to made this thread, and this protrude is “playing” as ridge, or top skirt at the cover or at the cup of chamber 12.1, and this element the protrude of chamber 12.1 is not carrying the substance as did that chamber 12.1. On FIG. 12C is shown outer protrude and absorber (hole) 12.5 of chamber body 12.1 which are entered to the corresponding absorber (hole) 12.3 shown on FIG. 12B in lien of thread 12.3 of chamber 12.1, and inner protrude (hole) 12.6 which are entered to the corresponding outer absorber (hole) 13.9 of closure 13.1 shown on FIG. 13B.

On FIGS. 13A÷13B are the schematic cross sectional view of closure 13.1 of body chamber. There on FIG. 13A is shown body of closure 13.1 manufactured whole and made from, for instance, ceramics material and used, for example, for drugs or medicine liquids, and where 13.2 is protrude of closure 13.1, and 13.3 is a hole of closure 13.1 for the output valve (is not shown at this figure), and 13.4 is a hole of closure 13.1 for outlet liquid substance, 13.5 is outlet itself for liquid substance and which is made together with closure 13.1, and 13.6 is protrude of closure 13.1 to fix the cover of valve (is not shown at this figure), 13.7 is outer thread of closure 13.1, and 13.8 is hole for junction stem (is not shown at this figure). On FIG. 13B is shown closure 13.1, outer protrude and hole 13.9 which are entered to corresponding inner protrude and hole which shown on FIG. 12C, and cover 13.10 and which is attached to closure 13.1, and used for push down the for output valve (is not shown at this figure). The cover 13.10 is made, for example, from plastic and used for liquid not hazardous for environment substances.

The rest particular assembly of package and method of it manufacture has been fully described in connection with the preferred embodiments thereof with reference to the accompanying drawings, it is to be noted that various changes and modifications will be apparent to those skilled in the art. Such changes and modifications are to be understand as included within the scope of the present invention as defined by the appended claims unless they depart therefrom.

We claimed:

The embodiments of the invention for which an exclusive privilege and property right is claimed are defined as follows:

1. A system for visible and automatically with a sound indicating fivefold of food or any substance body heated by microwave or any external source energy, comprising
(a) at thin electrically conductive nonmetal (ceramic, plastic or another nonmetal material) element having first and second opposed extended surfaces;
(b) element—sensor (indicator) means disposed on the first surface of the element for producing a visually observable and/or automatically regulate change of appearance upon being heated to a predetermined elevated inside and outside temperature or upon being maintained at such corresponding inside and outside temperature for a predetermined corresponding time;
(c) such predetermined external color of food body when elevated predetermined temperature equal corresponding time and temperature; when sensors of time and heat (function of really elevating temperature) equal to each other;
(d) number of foodstuff which is introducing by personnel stuff are constant during the same baked product; when the body of food is disposed in any external source energy for heating as well;
(e) nonmetallic element is also disposed in the oven with the sensor means positioned to be externally visible and/or automatically regulate change of appearance, and such the element receives source heat from the body by conduction and/or radiation as the body is heated by external energy;
(f) the dimensions of the element and the disposition of the sensor means thereon being such as substantially to shield the sensor means from temperature-elevating irradiation by external source energy.

2. A system as defined in claim 1a, when the heat is not constant for the same cooked product in the wide of product at the same regimes the said sensor with a high said elevated temperatures have to give automatically respond with said sound to change same said heated said element of external heated device like said microwave.

3. A system as defined in claim 1b, wherein said sensor means undergoes a physical said change upon attaining said predetermined elevated temperature.

4. A system as defined in claim 3, wherein said sensor means at such color of said external substance body when said elevated predetermined temperature said inside and/or said outside equal said corresponding time and temperature, when the body of said substance is disposed in any said external source energy as well as said for heating.

5. A system as defined in claim 4, wherein said sensor means includes a substance that said undergoes a change of state upon said attaining said predetermined said elevated temperature

6. A system as defined in claim 1b, wherein said sensor when said sensor indicating about said melt and said the sound is about high said temperature, and it is mean that said the temperature is very said high and nobody can work at this said temperature so long.

7. A system as defined in claim 1b, when said sensor chemically change of appearance this said sensor said indicating about said corresponding said change which is mean that this said sensor can not work properly so said long time and this said sensor have to said change to another more valuable said sensor.

8. A method of determining the fivefold of a body of said nonmetal said material said heated by said microwave or another said external sourse said energy comprising:
(a) placing in oven for said heating said body together with a thin electrically said conductive said nonmetal said material (said ceramic, plastic or another said nonmetal said material) said element having first and second opposed extended said surfaces;
(b) bearing on its first said surface said sensor (indicator) means for said producing a said visually observable and/or said automatically regulate change of said appearance upon being said heated to a said predetermined elevated inside and outside said temperature;
(c) upon being said maintained at such corresponding inside and outside said temperature for a said predetermined said corresponding time, and also at such said predetermined external color of food body when said elevated said predetermined said temperature equal said corresponding said time and said temperature;
(d) when said sensors of said time and said heat (said function of really elevating said temperature), and also a said number of foodstuff which is introducing by said personnel stuff are said constant during the same baked said product; when the said body of said food is disposed in any said external source energy as well for said heating, such that said nonmetallic element is also said disposed in the said oven with the said sensor means positioned to be said externally visible and/or said automatically said regulate said change of said appearance;
(e) such the said element receives said source heat from the said body by said conduction and/or said radiation as the said body is said heated by said external energy; the said dimensions of the said element and the said disposition of the said sensor means thereon being such as substantially to shield the said sensor means from said temperature-elevating said irradiation by said external source energy.

9. A method as defined in claim 8a, said change of said appearance occurs.

10. A method as defined in claim 8a, said regulate of heated said elements as needed said baked said product.

11. A method as defined in claim 8b,c, but part of said elements can be working as the same, or another said product, when another part of said elements can not be working at all.

12. A method as defined in claim 8d,e, but this said method minimizes of electrical, equipment, and said laboratory said stuff expenses.

13. A method as defined in claim 8d,e, but said heated said equipment for said baked of said food is said heated by said microwave or another said external energy comprising two or more said sections of industrial said equipment with interval between them. This said interval is used for cover of said food if it is needed.

14. A method as defined in claim 8e, but said industrial cover of said food devices are said elevated for clean them up.

15. A method as defined in claim 8e, but said industrial said microwave or another said external said source said energy has a few said heated said devices which is only for each said sensor.

16. A method as defined in claim 8e, but the said package of manufactured said food said product can make handle at the back of said package as needed this said food said product.

17. A method as defined in claim 8e, but the said package of said manufactured said food said product can be maked with hard plastic or another said material board as said needed this said food said product.

18. A package for keeping food product food industry in non-bacteria atmosphere, comprising:
(a) housing any form which is made a little bigger than sold said food said product;
(b) wrapper of housing which is optional, and
(c) exhaust valve for protect said food product said in non-bacteria atmosphere.

19. A package as claimed in claim 18a, in which said housing sometimes made with partition of said housing.

20. A package as claimed in claim 18b, the said housing and/or said wrapper made visible.

21. A package as claimed in claim 18b, the said housing further comprise comfortable to said food product adhesive layers at the each corner of said housing, and bonded area is fusion-bonded by the application of said heat.

22. A package as claimed in claim 18c, the said valve made a plurality and different high of side said housing or said wrapper.

23. A package as a chamber for substances from liquids using closure, internal pipe, and additional devices where said chamber have two thread (metrics—millimeters or nonmetrics—inches) with out of partition or with said partition for the said thread—one for the closure (always), and another said thread—for safety cover of said chamber if this second said thread is needed (if this said chamber has safety said cover, and some times this safety said cover is used as a cup for beverage or said food).

24. A package as a chamber as defined in claim 23, but cross section of this said chamber can be any shape—a circle form, a square form, a rectangle form, three angle form, and the same.

25. A package as a chamber as defined in claim 23, but said chamber and said closure both have protrude and absorbed, for instance, the said chamber has a said protrude and the said closure has an said absorbed. There is not a said thread for both of them in this case. There is only more bigger diameter of, for instance, up to said closure to fix said closure at the said chamber, the said absorbed of said closure is or are said accordingly entered to the said protrude of said chamber body. The said closure external said diameter is a little bit bigger than the internal said diameter of said chamber said head said body. There said closure entered tight planting to the said chamber said head by their said absorbed to the said protrude of said chamber said head. It gives the way for less said material and said energy consumption, low component cost, very high efficiency these said components, and low plant cost for relatively high volume throughput.

26. A package as a chamber as defined in claim 23, but if these said chamber made from acid-resistant said material, for instance, different kind of said ceramics, there possible to hold a biochemical or chemical said substance. It is more convenient to put in the amount of said substance as needed to the right place, as measured pipette (for drug) or medicine dropper.

27. A package as a chamber as defined in claim 23, but if these said chamber contains safety said cover this mean safe these said substances mainly from said children. Said tread belong to this said chamber and said cover (plastic or thermoplastic) and easy cut by any scissors or by any knife.

28. A package as a chamber as defined in claim 27, but said closure of said chamber consists of:
(a) output said closure's end and it's beginning is straight, and output said closure is folding also at the middle as well;
(b) cover's said closure folding also for said pretrude condition when said pretrude of this said cover is not said working, and this said cover is only for the said pretrude process.

29. A package as a chamber as defined in claim 27, but there is a said handle for said chamber body as it needed—for safety and for comfort. This said handle can be any said shape, as outside or the same said chamber with no said handle, and some said handle can be as paddle for the body said chamber. Also this said handle can fill in or fill out by said substance.

30. A package as a chamber as defined in claim 27, but there mainly is additional or supplementary glass or glasses (made from said glass, plastic or from the paper, and so on) for the water, beverage or for the food or medicine said substances.

31. A process for assembly said chamber for said substances from liquids comprising in the said mainly of body said chamber for said substances said mainly from said liquids, and additional devices such as two said thread of said chamber with said mainly said partition for the said thread, and said mainly said cover of said chamber with said tread, said mainly said cover for said closure and said output of it, said mainly filters for said substance said treating of small and big particles contamination of said held said substance, and stand for said chamber.

32. A process as defined in claim 31, this said chamber said helds not only said substances from said liquids and for pressurized said products, but also helds any kind of said substances.

33. A process as defined in claim 31, but if this said chamber made from said acid-resistant said material, then the said cover and the said closure are made from same said acid-resistant said material as well. In these case the said closure is not made whole. In these said case the said closure made as usual. And said cover is not folding, but reinforced separately. This said cover protects any one to use said substance out of reason.

34. A process as defined in claim 31, but said closure of said chamber is said manufactured as follows:
(a) said mainly whole of said closure said body;
(b) this said cover of said closure said folding which is for the said pretrude condition when said pretrude of this said cover is not said working and the said cover of said closure is only for the said pretrude said process;
(c) said closure's output said valve is said manufactured said separately, however, by the own said partition said valve is welded to the said body of the said closure. The said hole of said output said valve is made before this kind of said welding is made. The said hole for tail of this said valve is made right the same or a little smaller than the said tail of this said valve. This said hole is made with out of output said valve because there is not possibility to said make said hole the same time as said output said valve tail. Finally there is not spring of this said valve, and said closure whole. Finally these said closure made said whole. This said valve being movable within a drilled hole.

35. A process as defined in claim 34a, but there of said chamber is a lever where it needed for measure level of said substance. There is used stable or instant said lever.

36. A process as defined in claim 34a, but there of said chamber is said easy to clean up all of said parts if this said parts neaded of clean up and which mentioned and not said mentioned yet above.
